(19) United States
(12) Patent Application Publication
(10) Pub. No.: US 2016/0318129 A1
(43) Pub. Date: Nov. 3, 2016

(54) SYSTEM AND METHOD FOR MULTI-LASER ADDITIVE MANUFACTURING

(71) Applicant: General Electric Company, Schenectady, NY (US)

(72) Inventor: Zhaoli Hu, Greer, SC (US)

(21) Appl. No.: 15/143,751

(22) Filed: May 2, 2016

Related U.S. Application Data
(60) Provisional application No. 62/155,528, filed on May 1, 2015.

(51) Int. Cl. B23K 26/342; B23K 26/082; B23K 26/06; B23K 26/144

(52) U.S. Cl. CPC B23K 26/342; B23K 26/144; B23K 26/082; B23K 26/0608; B33Y 10/00

(57) ABSTRACT

A system and method for additive manufacturing an object using multiple lasers is disclosed herein. The system includes a first laser generating a first focused laser beam having a first surface area where the first focused laser beam is directed onto a first quantity of a powder material on a substrate so as to fuse particles of the powder material in a first layer of the substrate. A second laser generating a second focused laser beam having a second surface area where the second laser beam is directed onto a second quantity of the powder material on the substrate so as to fuse particles of the powder material in the first layer of the substrate. The first surface area of the first focused laser beam is greater than the second surface area of the second focused laser beam.

### CROSS REFERENCE TO RELATED APPLICATIONS

The present application claims filing benefit of U.S. Provisional Patent Application Ser. No. 62/155,528 having a filing date of May 1, 2015, which is incorporated by reference herein in its entirety.

### FIELD OF THE INVENTION

The present invention generally relates to a system and method for additively manufacturing an object or part. More particularly, this invention involves a system and a method for additively manufacturing using more than one laser to form a single object or part.

### BACKGROUND OF THE INVENTION

Additive manufacturing processes generally involve the buildup of one or more materials to make a net or near net shape (NNS) object, in contrast to subtractive manufacturing methods. Though “additive manufacturing” is an industry standard term, additive manufacturing encompasses various manufacturing and prototyping techniques known under a variety of additive manufacturing terms, including freeform fabrication, 3D printing, rapid prototyping/tooling, etc. Additive manufacturing techniques are capable of fabricating complex components from a wide variety of materials. Generally, a freestanding object can be fabricated from a computer aided design (CAD) model.

A particular type of additive manufacturing process uses an energy beam, for example, an electron beam or electromagnetic radiation such as a laser beam, to sinter or melt a powder material, creating a solid three-dimensional object in which particles of the powder material are bonded together. Different material systems, for example, engineering plastics, thermoplastic elastomers, metals, and ceramics are in use. Laser sintering or melting is also a notable additive manufacturing process for rapid fabrication of functional prototypes and tools. Applications include patterns for investment casting, metal molds for injection molding and die casting, and molds and cores for sand casting. Fabrication of prototype objects to enhance communication and testing of concepts during the design cycle are other common usages of additive manufacturing processes.

Laser sintering is a common industry term used to refer to producing three-dimensional (3D) objects by using a laser beam to sinter or melt a fine powder. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material.

Laser sintering/melting techniques often entail projecting a single laser beam such as a continuous wave (CW) laser or a pulsed beam laser, typically a Nd: YAG laser, onto a controlled amount of powder (usually a metal) material on a substrate, so as to form a layer of fused particles or molten material thereon. By moving the laser beam relative to the substrate along a predetermined path, often referred to as a scan pattern, the layer can be defined in two dimensions on the substrate, the width of the layer being determined by the diameter of the laser beam where it strikes the powder material. Scan patterns often comprise parallel scan lines, also referred to as scan vectors or hatch lines, and the distance between two adjacent scan lines is often referred to as hatch spacing, which is usually less than the diameter of the laser beam so as to achieve sufficient overlap to ensure complete sintering or melting of the powder material. Repeating the movement of the laser along all or part of a scan pattern enables further layers of material to be deposited and then sintered or melted, thereby fabricating a three-dimensional object.

The time required to manufacture a part is a large concern with currently known additive manufacturing processes. One factor which negatively effects manufacturing time is the size of the focused beam size which is generally about 50 μm-100 μm in diameter. The smaller the focused beam size, the more scan passes that are required to form a completed part. However, for highly detailed features to be formed on a part, the smaller focused beam size may be necessary.

In view of the above, it can be appreciated that there are certain limitations associated with laser sintering and melting techniques. Thus it would be desirable if improved methods and equipment were available that are capable of increasing manufacturing time of parts formed via the additive manufacturing process.

### BRIEF DESCRIPTION OF THE INVENTION

Aspects and advantages of the invention are set forth below in the following description, or may be obvious from the description, or may be learned through practice of the invention.

Another embodiment of the present application is a system for additive manufacturing an object using multiple lasers. The system includes a first laser that generates a first focused laser beam having a first surface area. The first focused laser beam is directed onto a first quantity of a powder material on a substrate so as to fuse particles of the powder material in a first layer of the substrate. The system further includes a second laser that generates a second focused laser beam having a second surface area. The second laser beam is directed onto a second quantity of the powder material on the substrate so as to fuse particles of the powder material in the first layer of the substrate. The first surface area of the first focused laser beam is greater than the second surface area of the second focused laser beam.

Another embodiment of the present invention is a method for additively manufacturing an object. The method includes directing a first focused laser beam having a first surface area from a first laser onto a first quantity of a powder material on a substrate so as to fuse particles of the powder material in a first layer of the substrate and directing a second focused laser beam having a second surface area from a second laser onto a second quantity of the powder material on the substrate so as to fuse particles of the powder material in the first layer of the substrate. The first laser and the second laser are energized simultaneously.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 illustrates a schematic of a system for additive manufacturing an object according to various embodiments of the present invention;

FIG. 2 is an enlarged top view of a substrate portion of the system as shown in FIG. 1 according to various embodiment of the present invention;

FIG. 3 is an top view of an exemplary focused laser beam shape;

FIG. 4 is an top view of an exemplary focused laser beam shape;

FIG. 5 is an top view of an exemplary focused laser beam shape;

FIG. 6 is an top view of an exemplary focused laser beam shape; and

FIG. 7 is an enlarged top view of a substrate portion of the system as shown in FIG. 1 according to various embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The term “additive manufacturing” as used herein refers to any process which results in a useful, three-dimensional object and includes a step of sequentially forming the shape of the object one layer at a time. Additive manufacturing processes include three-dimensional printing (3DP) processes, laser-net-shape manufacturing, direct metal laser sintering (DMLS), direct metal laser melting (DMLM), plasma transferred arc, freeform fabrication, etc. A particular type of additive manufacturing process uses an energy beam, for example, an electron beam or electromagnetic radiation such as a laser beam, to sinter or melt a powder material. Additive manufacturing processes often employ relatively expensive metal powder materials or wire as a raw material. An example of a 3DP process may be found in U.S. Pat. No. 6,036,777 to Sachs, issued Mar. 14, 2000.

The present invention relates generally to additive manufacturing processes as a rapid way to manufacture an object (article, component, part, product, etc.) where a multiplicity of thin unit layers are sequentially formed via two or more lasers acting independently to simultaneously produce the object. More specifically, layers of a powder material are laid down and irradiated with two separate energy beams (e.g., laser beams) so that particles of the powder material within each layer are sequentially sintered (fused) or melted to solidify the layer.

Detailed descriptions of laser sintering/melting technology may be found in U.S. Pat. No. 4,863,538, U.S. Pat. No. 5,017,753, U.S. Pat. No. 5,076,869, and U.S. Pat. No. 4,944,817. With this type of manufacturing process as provided herein, two or more laser beams are used to selectively fuse a powder material by scanning cross-sections of the material in a bed. These cross-sections are scanned based on a three-dimensional description of the desired object. This description may be obtained from various sources such as, for example, a computer aided design (CAD) file, scan data, or some other source.

According to certain aspects of the invention, the powder material can be a metallic material, non-limiting examples of which include aluminum and its alloys, titanium and its alloys, nickel and its alloys, stainless steels, cobalt-chrome alloys, tantalum, and niobium. Methods of producing a three-dimensional structure may include depositing a first layer of one or more of the aforementioned powder materials on a substrate. At least one additional layer of powder material is deposited and then the laser scanning steps for each successive layer are repeated until a desired object is obtained. In fabricating a three-dimensional structure, the powder material can be either applied to a solid base or not. The article is formed in layer-wise fashion until completion. In the present invention, a first laser generates a first focused laser beam having a first diameter and/or surface area. The first focused laser beam is scanned across the substrate in order to form bulk portions or portions of the object that do not include complex or highly detailed features. Simultaneously, a second laser generates a second focused laser beam having a second diameter and/or surface area that is smaller or less than the first diameter and/or surface area. The two lasers working together to form a single object decreases overall manufacturing time for forming the completed object.

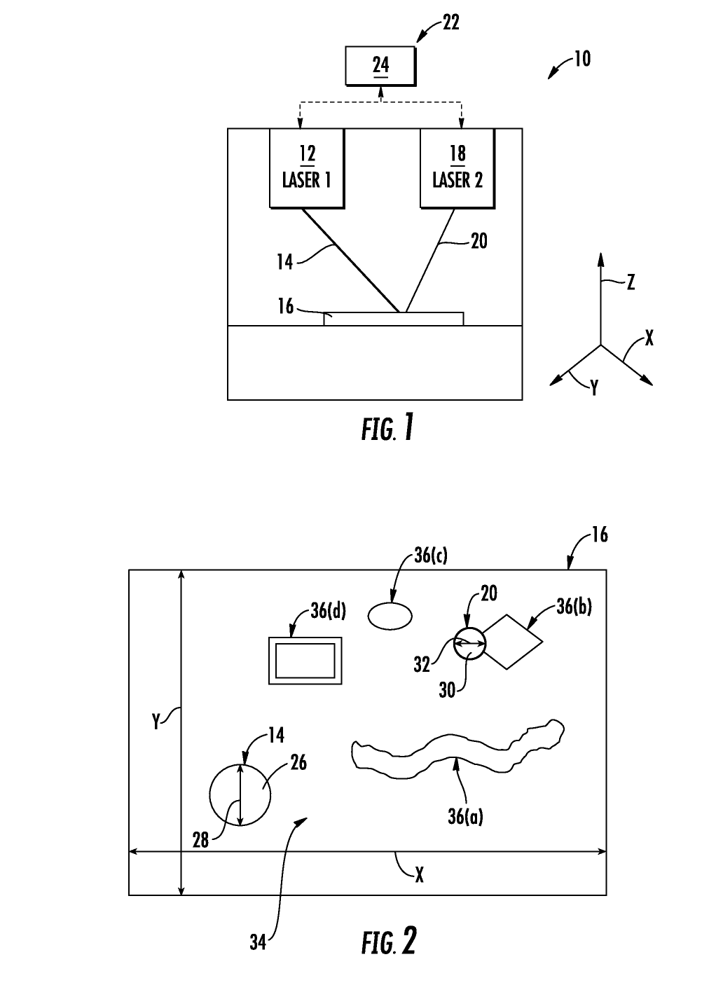

Referring now to the drawings, FIG. 1 illustrates a system for additive manufacturing an object 10 herein referred to as “system” according to various embodiments of the present invention. As shown in FIG. 1, the system 10 includes a first laser 12 that generates a first focused laser beam 14 that is directed onto a first quantity of a powder material disposed on a substrate 16. The first focused laser beam 14 is directed so as to fuse particles of the powder material in a first layer of the substrate 16. The system 10 further includes a second laser 18 that generates a second focused laser beam 20 that is directed onto a second quantity of the powder material on the substrate 16 so as to fuse particles of the powder material in the first layer of the substrate 16. The first laser 12 and second laser 18 may operate independently or together. In various embodiments, the first laser 12 and the second laser 18 are energized simultaneously.

The system 10 may also include a control system 22 including a controller 24 and/or one or more articulating members (not shown). The controller 24 may be configured or programmed to control power to the first and/or the second laser 12, 18 and/or to control position (X, Y and Z coordinates) of and/or scan velocity for each or either of the first laser 12 and the second laser 18. For example, in various embodiments, the control system 22 may articulate the first laser 12 at a scan velocity that is between about 1 m/sec and about 6 m/sec. In various embodiments, the control system 22 may articulate the second laser 18 at a scan velocity that is between about 1 m/sec and about 3 m/sec.

The first laser 12 may be a fiber laser, a diode laser or any laser suitable to provide the first focused laser beam 14 at a suitable power across a particular surface area and/or diameter. This measurement is generally known as power density (Power/Area). In various embodiments, the first laser 12 may provide the first focused laser beam 14 at a power that is greater than 400 W. In various embodiments, the first laser 12 may provide the first focused laser beam 14 at a power that is greater than 1 KW. In various embodiments, the first laser 12 may provide the first focused laser beam 14 at a power that is greater than 2 KW.

The second laser 18 may be a fiber laser, a diode laser or any laser suitable to provide the second focused laser beam 20 at a suitable power across a particular surface area and/or diameter. In particular embodiments, the second laser 18 is a fiber laser. In various embodiments, the second laser 18 may provide the second focused laser beam 20 at a power that is between about 200 W and about 400 W.

FIG. 2 provides an enlarged top view of the substrate 16 as shown in FIG. 1. As shown in FIG. 2, the first focused laser beam 14 has a first surface area 26. For example, in particular embodiments, the first surface area 26 of the first focused laser beam 14 may be between about 700 μm² to about 3.14×10⁴ μm². In particular embodiments, the first surface area 26 of the first focused laser beam 14 may be greater than about 3.14×10⁴ μm². In particular embodiments, where the first focused laser beam 14 has a circular or round shape, the first focused laser beam 14 may have first diameter 28 that is between about 30 μm and about 200 μm. In particular embodiments, where the first focused laser beam 14 has a circular or round shape, as shown in FIG. 2, the first focused laser beam 14 may have first diameter 28 that is greater than 200 μm.

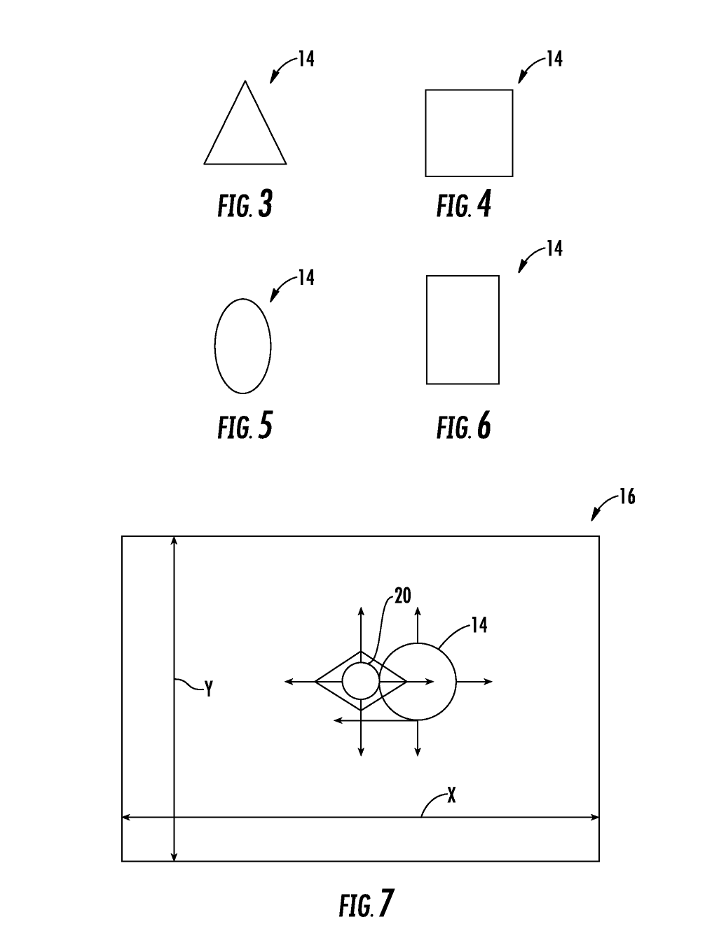

FIGS. 3-6 provide various exemplary non-round or non-circular shapes for the first focused laser beam 14. For example, the first laser beam 14 may have a substantially triangular shape as shown in FIG. 3. As shown in FIG. 4, the first laser beam 14 may have a substantially square shape. As shown in FIG. 5, the first laser beam 14 may have a substantially oval shape. As shown in FIG. 6, the first laser beam 14 may have a substantially rectangular shape. The non-circular or non-round shapes may be provided by using diodes or other laser beam shaping means.

As shown in FIG. 2, the second focused laser beam 20 has a second surface area 30 and/or a second diameter 32 that is less than the first surface area 26 and/or the first diameter 28 of the first focused laser beam 14. For example, in various embodiments, the second surface area 30 of the second focused laser beam 20 may be between about 700 μm² to about 1.9×10³ μm². The second focused laser beam 20 may have a second diameter 32 that is between about 30 um and 50 um.

The first focused laser beam 14 is generally larger than the second focused laser beam 20, thus allowing for the first focused laser beam 14 to form a larger portion of the object while allowing the second focused laser beam 20 to form more detailed features of the object. For example, as shown in FIG. 2, the first focused laser beam 14 may be used to form a bulk portion of the object while the second focused laser 20 may be used simultaneously to form complex or detailed features 36(a-d) of the object. For example, the second focused laser beam 20 may be used to form channels or passages 36(a), triangular or diamond shaped features 36(b), spherical or oval shaped features 36(c), slots or voids 36(d) or any other complex or detailed feature of the object.

The system as illustrated and described herein provides a method for additively manufacturing an object. For example, the method may include directing the first focused laser beam 14 from the first laser 12 at the first surface area 26 and/or diameter 28 onto a first quantity of a powder material on the substrate 16 so as to fuse particles of the powder material in a first layer of the substrate 16. The method may further include directing the second focused laser beam 20 from the second laser 18 at the second surface area 30 and/or the second diameter 32 onto a second quantity of the powder material on the substrate so as to fuse particles of the powder material in the first layer of the substrate where the first laser 12 and the second laser 18 are energized simultaneously.

The method may include scanning the first laser 12 or the first focused laser beam 14 across the substrate at a scan velocity that is between about 1 m/sec and about 6 m/sec. The method may include scanning the second laser 18 or the second focused laser beam 20 across the substrate at a scan velocity that is between about 1 m/sec and about 3 m/sec. The method may include setting the power of the first laser 12 to provide a focused laser beam at a power of between about 200 W and about 400 W. The method may include setting the power of the first laser 12 to provide a focused laser beam at a power that is greater than 400 W. The method may include setting the power of the first laser 12 to provide a focused laser beam at a power that is greater than 1 KW. The method may include setting the power of the first laser 12 to provide a focused laser beam at a power that is greater than 2 KW.

In various embodiments, as shown in FIG. 7, the method may include directing or overlap the first focused laser beam 14 across a portion of the powder material so as to heat treat a portion of the second quantity of the powder material without melting the powder material and then directing the second focused laser beam 20 across the same portion of the powder material to fuse the particles of the powder material in the layer of the substrate 16.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal language of the claims.

What is claimed is:

1. A system for additive manufacturing an object, comprising:
a first laser generating a first focused laser beam having a first surface area, wherein the first focused laser beam is directed onto a first quantity of a powder material on a substrate so as to fuse particles of the powder material in a first layer of the substrate; and
a second laser generating a second focused laser beam having a second surface area, wherein the second laser beam is directed onto a second quantity of the powder material on the substrate so as to fuse particles of the powder material in the first layer of the substrate;
wherein the first surface area of the first focused laser beam is greater than the second surface area of the second focused laser beam.

2. The system as in claim 1, wherein the first focused laser beam has a diameter of between about 50 um and 200 um.

3. The system as in claim 1, wherein the first focused laser beam has a diameter of greater than 200 um.

4. The system as in claim 1, wherein the second focused laser beam has a diameter of between about 30 um and 50 um.

5. The system as in claim 1, wherein the first laser has a scan velocity that is between about 1 m/sec and about 6 m/sec.

6. The system as in claim 1, wherein the second laser has a scan velocity that is between about 1 m/sec and about 3 m/sec.

7. The system as in claim 1, wherein the first laser provides the first focused laser beam at a power that is greater than 400 W.

8. The system as in claim 1, wherein the first laser provides the first focused laser beam at a power that is greater than 1 KW.

9. The system as in claim 1, wherein the first laser provides the first focused laser beam at a power that is greater than 2 KW.

10. The system as in claim 1, wherein the second laser provides the second focused laser beam at a power of between about 200 W and about 400 W.

11. The system as in claim 1, wherein the first laser is a fiber laser.

12. The system as in claim 1, wherein the first laser is a diode laser.

13. The system as in claim 1, wherein the second laser is a fiber laser.

14. The system as in claim 1, wherein the first focused laser beam has a non-circular shape.

15. The system as in claim 1, wherein the first focused laser beam is provided at a power level that pre-heats a portion of the second quantity of the powder material without melting the powder material.

16. The system as in claim 1, wherein the first focused laser beam overlaps a portion of the second quantity of the powder material.

17. A method for additively manufacturing an object, comprising:
directing a first focused laser beam having a first surface area from a first laser onto a first quantity of a powder material on a substrate so as to fuse particles of the powder material in a first layer of the substrate; and
directing a second focused laser beam having a second surface area from a second laser onto a second quantity of the powder material on the substrate so as to fuse particles of the powder material in the first layer of the substrate;
wherein the first laser and the second laser are energized simultaneously.

18. The method as in claim 17, wherein a first diameter of the first focused laser beam is greater than a second diameter of the second focused laser beam.

19. The method as in claim 18, wherein the second diameter of the second focused laser beam is between about 30 um and 50 um.

20. The method as in claim 19, wherein the first diameter of the first focused laser beam is between about 50 um and 200 um.

21. The method as in claim 19, wherein the first diameter of the first focused laser beam is greater than 200 um.

22. The method as in claim 17, wherein the second laser has a scan velocity that is between about 1 m/sec and about 3 m/sec.

23. The method as in claim 17, wherein the first laser has a scan velocity that is between about 1 m/sec and about 6 m/sec.

24. The method as in claim 17, wherein the first laser provides the first focused laser beam at a power of between about 200 W and about 400 W.

25. The method as in claim 17, wherein the first laser provides the first focused laser beam at a power that is greater than 400 W.

26. The method as in claim 17, wherein the first laser provides the first focused laser beam at a power that is greater than 1 KW.

27. The method as in claim 17, wherein the first laser provides the first focused laser beam at a power that is greater than 2 KW.

28. The method as in claim 17, wherein the first laser is a fiber laser.

29. The method as in claim 17, wherein the first laser is a diode laser.

30. The method as in claim 17, wherein the first focused laser beam has a non-circular shape.

31. The method as in claim 17, wherein the second focused laser beam is provided at a power level that heat treats a portion of the first quantity of the powder material without melting the powder material.

32. The method as in claim 17, wherein the second focused laser beam overlaps a portion of the first quantity of the powder material.
